(19) United States
(12) Patent Application Publication
(10) Pub. No.: US 2012/0082298 A1
(43) Pub. Date: Apr. 5, 2012

(54) RADIOLOGICAL IMAGE DISPLAYING DEVICE AND METHOD

(75) Inventor: Takashi TAJIMA, Ashigarakami-gun (JP)

(73) Assignee: FUJIFILM CORPORATION, Tokyo (JP)

(21) Appl. No.: 13/248,664

(22) Filed: Sep. 29, 2011

(30) Foreign Application Priority Data
Sep. 30, 2010 (JP) 2010-220522

(51) Int. Cl. H05G 1/64

(52) U.S. Cl. 378/98

(57) ABSTRACT

A problem at the time of stereoscopic viewing of auxiliary lines for making a three-dimensional effect easy to figure out when displaying a stereoscopic image using a radiological image is solved. Auxiliary lines are added to two radiological images for displaying a stereoscopic image. The auxiliary lines are formed by a plurality of grids arrayed so as to be viewed in the depth direction. Lines which form the grids are disposed at positions, which are distant from positions vertically facing a focal point at the time of radiographing, on the radiological images. In addition, the lines which form the grids may be disposed at positions distant from a position, which bisects positions vertically facing a plurality of focal points at the time of radiographing when acquiring the radiological images, on each of the radiological images.

### BACKGROUND OF THE INVENTION

1. Field of the Invention

The present invention relates to a radiological image display device and method for displaying a stereoscopic image of a subject.

2. Description of the Related Art

In the related art, realizing stereoscopic viewing using parallax by displaying a combination of a plurality of images is known. Such an image which can be stereoscopically viewed (hereinafter, referred to as a stereoscopic image or a three-dimensional image) is displayed based on a plurality of images with parallax acquired by radiographing the same subject from different directions.

Various methods have been proposed to make easy to figure out the three-dimensional effect of the structure included in an image when such a stereoscopic image is displayed. For example, in the method disclosed in JP2006-271739A, corresponding points corresponding to each other on two fundus images, which are for displaying an image of the fundus oculi as a stereoscopic image and are acquired by radiographing the fundus oculi from different directions, are calculated and a contour showing the same depth in the fundus oculi is given to the two fundus images based on the corresponding points. Thus, a sense of depth of the fundus oculi can be easily figured out by displaying a stereoscopic image using the fundus images to which the contour is given. Moreover, in the method disclosed in JP2006-271739A, the color of the contour line changes according to the depth in order to make a difference in the sense of depth of the fundus oculi easily recognized.

In addition, a method of displaying a grid line showing the depth direction when displaying an image to be measured in a three-dimensional manner has been proposed as a method of making easy to figure out a sense of depth of a stereoscopic image (refer to JP2009-053147A).

Moreover, such way of generating stereoscopic image is utilized not only in the field of digital cameras and televisions but also in the field of radiography. That is, a subject is irradiated from different radiographing directions, radiation transmitted through the subject is detected by a radiation detector to acquire a plurality of radiological images with parallax, and a stereoscopic image is displayed using these radiological images. Since a radiological image can be observed with a sense of depth by using such a stereoscopic image, diagnosis can be more easily performed.

### SUMMARY OF THE INVENTION

Incidentally, since a radiological image is a transfer image inside a subject, structures, such as bones, various tissues, and tumors or calcified lesions, present inside the subject are included in the radiological image in a state overlapping each other. Accordingly, when displaying a stereoscopic image using a radiological image, the structure with a three-dimensional effect is stereoscopically viewed so as to float in a space. For this reason, it is difficult to figure out a sense of depth of the structure on the stereoscopic image of the radiological image. In addition, when displaying a stereoscopic image, making a required instruction on an image using a three-dimensional cursor, which is movable not only in a planar direction but also in the depth direction, may be considered. In this case, however, it is difficult to match a sense of depth of the three-dimensional cursor with a sense of depth of the part of interest, such as a lesion, in the stereoscopic image. For this reason, when displaying a stereoscopic image using a radiological image, it is considered to make easy to figure out a sense of depth by displaying auxiliary lines, which are formed by arraying a plurality of mesh-like grids with different senses of depth, so as to be able to be stereoscopically viewed.

When such auxiliary lines are added to the radiological image, however, the auxiliary lines may not be able to be stereoscopically viewed depending on the positions of the auxiliary lines. In addition, a distance between the auxiliary lines may be reduced and this may make it difficult to observe the radiological image, or the auxiliary lines may flicker and this may lead to the fatigue of eyes.

The method disclosed in JP2006-271739A is for giving to an image the contour showing the same depth in the image, but does not solve the above-described problems, such as a problem in that auxiliary lines cannot be stereoscopically viewed. In addition, the method disclosed in JP2009-053147A is for displaying grid lines at the position, which is set in advance, on an image in order to measure the three-dimensional effect, but does not solve the above-described problems, such as a problem in that auxiliary lines cannot be stereoscopically viewed, similar to the method disclosed in JP2006-271739A.

The present invention has been made in view of the above-mentioned problems and an object of the present invention is to solve a problem at the time of stereoscopic viewing of auxiliary lines for making easy to figure out a three-dimensional effect when displaying a stereoscopic image using a radiological image.

According to a first aspect of the present invention, there is provided a radiological image display device including: an image acquisition unit that acquires a plurality of radiological images for displaying a stereoscopic image of a subject; a display control unit that displays the stereoscopic image on a display unit using the plurality of radiological images; an auxiliary line adding unit that adds auxiliary lines, which are formed by arraying a plurality of grids each of which is divided into a plurality of regions in the shape of a mesh so as to be viewed in a depth direction, to the plurality of radiological images so as to be able to be stereoscopically viewed; and an auxiliary line generating unit that generates the auxiliary lines such that lines which form the grids are disposed at positions, which are distant from a position vertically facing a focal point at the time of radiographing, on the radiological images when adding the auxiliary lines to the radiological images.

Although any kind of shape, such as a rectangle, a circle, and a triangle, may be used as the shape of a grid, a rectangle is preferable.

In addition, in the radiological image display device according to the first aspect of the present invention, the auxiliary line generating unit may be a unit that generates the auxiliary lines such that the lines which form the grids are disposed at positions distant from a position, which bisects positions vertically facing a plurality of focal points at the time of radiographing when acquiring the plurality of radiological images, on each of the radiological images when adding the auxiliary lines to the radiological images.

According to a second aspect of the present invention, there is provided a radiological image display device including: an image acquisition unit that acquires a plurality of radiological images for displaying a stereoscopic image of a subject; a display control unit that displays the stereoscopic image on a display unit using the plurality of radiological images; an auxiliary line adding unit that adds auxiliary lines, which are formed by arraying a plurality of grids each of which is divided into a plurality of regions in the shape of a mesh so as to be viewed in a depth direction, to the plurality of radiological images so as to be able to be stereoscopically viewed; and an auxiliary line generating unit that generates the auxiliary lines such that lines which form the grids are disposed at positions distant from a position, which bisects positions vertically facing a plurality of focal points at the time of radiographing when acquiring the plurality of radiological images, on each of the radiological images when adding the auxiliary lines to the radiological images.

According to a third aspect of the present invention, a radiological image display method in a radiological image display device including an image acquisition unit that acquires a plurality of radiological images for displaying a stereoscopic image of a subject and a display control unit that displays the stereoscopic image on a display unit using the plurality of radiological images includes: when adding auxiliary lines, which are formed by arraying a plurality of grids each of which is divided into a plurality of regions in the shape of a mesh so as to be viewed in a depth direction, to the plurality of radiological images so as to be able to be stereoscopically viewed, generating the auxiliary lines such that lines which form the grids are disposed at positions, which are distant from a position vertically facing a focal point at the time of radiographing, on the radiological images.

According to a fourth aspect of the present invention, a radiological image display method in a radiological image display device including an image acquisition unit that acquires a plurality of radiological images for displaying a stereoscopic image of a subject and a display control unit that displays the stereoscopic image on a display unit using the plurality of radiological images includes: when adding auxiliary lines, which are formed by arraying a plurality of grids each of which is divided into a plurality of regions in the shape of a mesh so as to be viewed in a depth direction, to the plurality of radiological images so as to be able to be stereoscopically viewed, generating the auxiliary lines such that lines which form the grids are disposed at positions distant from a position, which bisects positions vertically facing a plurality of focal points at the time of radiographing when acquiring the plurality of radiological images, on each of the radiological images.

When lines which form grids of auxiliary lines for assisting stereoscopic viewing of a radiological image are located at the position vertically facing the focal point at the time of radiographing on the radiological image, the auxiliary lines need to be generated by disposing the grids such that the lines which form all grids are viewed so as to overlap the positions for stereoscopic viewing of the auxiliary lines. However, the stereoscopic viewing is performed using parallax of the corresponding positions when displaying a plurality of images simultaneously. For this reason, if grid lines on one of two radiological images for displaying a stereoscopic image overlap each other, it is not clear to which lines on the other radiological image the overlapping lines correspond. Accordingly, stereoscopic viewing of auxiliary lines is difficult in a part where grid lines overlap each other. In addition, even if the arrangement of lines is changed such that grid lines do not overlap each other, it may be difficult to observe a radiological image if a distance between the lines is narrow, or auxiliary lines may flicker and this may lead to the fatigue of eyes.

In the radiological image display device according to the first aspect of the present invention and the radiological image display method according to the third aspect of the present invention, when adding auxiliary lines to a radiological image, the auxiliary lines are generated such that the lines which form grids are disposed at the positions distant from the position vertically facing the focal point at the time of radiographing on the radiological image. For this reason, auxiliary lines can be generated such that the lines which form all grids are located far from the position vertically facing the focal point. As a result, it is possible to prevent stereoscopic viewing of auxiliary lines from becoming difficult when displaying a stereoscopic image using radiological images to which the auxiliary lines are added. In addition, since the distance between lines which form the auxiliary lines is increased, it becomes easy to observe a radiological image. In addition, since flickering of the auxiliary lines can be suppressed, the fatigue of eyes can also be prevented.

On the other hand, if lines which form grids of auxiliary lines are located at the position, which bisects the positions vertically facing a plurality of focal points at the time of radiographing when acquiring a plurality of radiological images, on each of the radiological images, lines which form the grids are located on the position which bisects focal points at the time of radiographing when performing stereoscopic viewing. Therefore, from the characteristics of human vision, it is clear from the experiments of this applicant that the lines which form grids cannot be stereoscopically viewed well.

In the radiological image display device according to the second aspect of the present invention and the radiological image display method according to the fourth aspect of the present invention, when adding auxiliary lines to radiological images, the auxiliary lines are generated such that the lines which form grids are disposed at the positions distant from a position, which bisects positions vertically facing a plurality of focal points at the time of radiographing when acquiring the plurality of radiological images, on each of the radiological images. Accordingly, when performing stereoscopic viewing, the lines which form grids are not located at the position which bisects the positions vertically facing a plurality of focal points at the time of radiographing. As a result, it is possible to prevent stereoscopic viewing of the auxiliary lines from becoming difficult.

### BRIEF DESCRIPTION OF THE DRAWINGS

FIG. 1 is a view showing the schematic configuration of a radiological image radiographing apparatus to which a radiological image display device according to a first embodiment of the present invention is added.

FIG. 2 is a view when an arm unit of the radiological image radiographing apparatus shown in FIG. 1 is seen from the right side of FIG. 1.

FIG. 3 is a block diagram showing the schematic configuration inside a computer of the radiological image radiographing apparatus shown in FIG. 1.

FIG. 4 is a view showing an auxiliary line.

FIG. 5 is a view showing the positional relationship between a radiation source and a radiation detector at the time of radiographing seen from the right side of FIG. 1.

FIG. 6 is a view showing a state where a stereoscopic image is stereoscopically viewed based on the positional relationship between a radiation source and a radiation detector.

FIG. 7 is a view showing a state where auxiliary lines are added such that lines which form three grids exist at the positions immediately below the left eye.

FIG. 8 is a view for explaining the generation of an auxiliary line in the first embodiment.

FIG. 9 is a view showing a radiological image to which an auxiliary line generated in the first embodiment is added.

FIG. 10 is a flow chart showing the processing performed in the first embodiment.

FIG. 11 is a view showing a radiological image to which an auxiliary line generated in a second embodiment is added.

### DESCRIPTION OF THE PREFERRED EMBODIMENTS

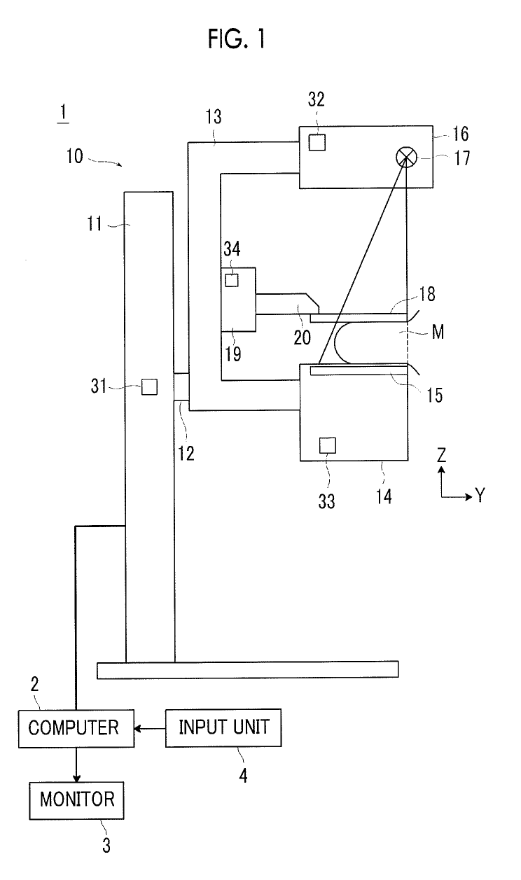

Hereinafter, embodiments of the present invention will be described with reference to the accompanying drawings. FIG. 1 is a view showing the schematic configuration of a radiological image radiographing apparatus to which a radiological image display device according to an embodiment of the present invention is added. A radiological image radiographing apparatus 1 according to the present embodiment acquires a plurality of radiological images by radiographing a breast M from different radiographing directions in order to generate a stereoscopic image for stereoscopic viewing of a radiological image of the breast M. As shown in FIG. 1, the radiological image radiographing apparatus 1 includes a radiographing unit 10 which includes image acquisition means (not shown), a computer 2 connected to the radiographing unit 10, and a monitor 3 (display unit) and an input unit 4 connected to the computer 2.

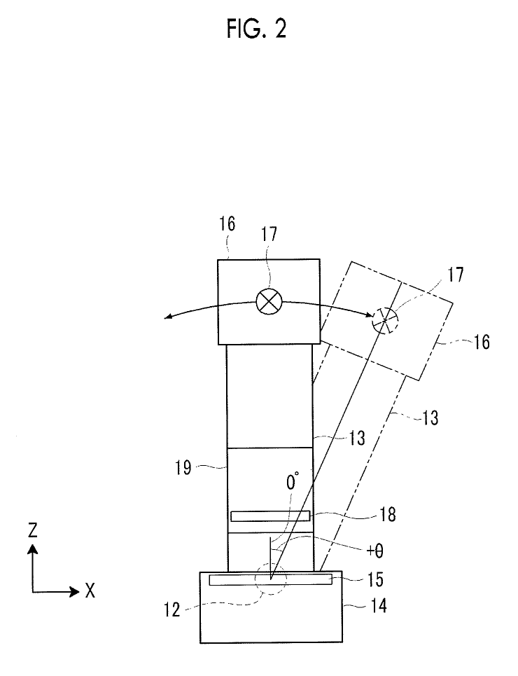

The radiographing unit 10 includes a pedestal 11, a rotary shaft 12 which can rotate and move up and down (in the Z-axis direction) with respect to the pedestal 11, and an arm unit 13 connected to the pedestal 11 by the rotary shaft 12. In addition, FIG. 2 shows the arm unit 13 when viewed from the right side in FIG. 1.

The arm unit 13 has a shape of a letter C. A radiation plane 14 is fixed to one end of the arm unit 13, and an irradiating unit 16 is fixed to the other end so as to face the radiation plane 14. Rotation and up-and-down movement of the arm unit 13 are controlled by an arm controller 31 provided in the pedestal 11.

A radiation detector 15, such as a flat panel detector, and a detector controller 33 which controls reading of a charge signal from the radiation detector 15 are provided inside the radiation plane 14.

In addition, a circuit board on which a charge amplifier that converts a charge signal read from the radiation detector 15 into a voltage signal, a correlated double sampling circuit that samples a voltage signal output from the charge amplifier, an AD converter that converts a voltage signal into a digital signal, and the like are provided is placed inside the radiation plane 14.

In addition, the radiation plane 14 is configured to be able to rotate with respect to the arm unit 13. Accordingly, even when the arm unit 13 rotates with respect to the pedestal 11, the direction of the radiation plane 14 can be fixed with respect to the pedestal 11.

The radiation detector 15 can perform recording and reading of a radiological image repeatedly. A so-called direct-conversion type radiation detector which generates an electric charge by direct reception of radiation may be used, or a so-called indirect-conversion type radiation detector which converts radiation into visible light and then converts the visible light into a charge signal may be used. Moreover, as a method of reading a radiological image signal, a so-called TFT reading method in which a radiological image signal is read by ON/OFF of a TFT (thin film transistor) switch or a so-called optical reading method in which a radiological image signal is read by irradiation of reading light is preferably used. However, other methods may be used without being limited to the above methods.

A radiation source 17 and a radiation source controller 32 are provided in the irradiating unit 16. The radiation source controller 32 controls an irradiation timing of radiation from the radiation source 17 and the radiation generating conditions (tube current, time, tube current time product, and the like) in the radiation source 17.

In addition, a compression plate 18 provided above the radiation plane 14 to compress a breast, a supporting unit 20 which supports the compression plate 18, and a moving mechanism 19 which moves the supporting unit 20 up and down (in the Z-axis direction) are provided in the middle of the arm unit 13. The position and the pressure of the compression plate 18 are controlled by a compression plate controller 34.

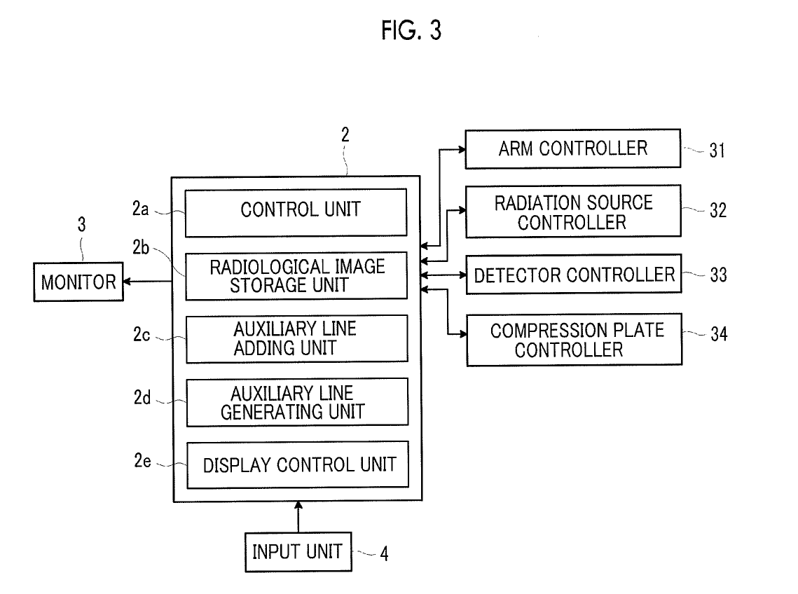

The computer 2 includes a central processing unit (CPU) and a storage device, such as a semiconductor memory, a hard disk, or an SSD. By such hardware, a control unit 2a, a radiological image storage unit 2b, an auxiliary line adding unit 2c, an auxiliary line generating unit 2d, and a display control unit 2e shown in FIG. 3 are formed.

The control unit 2a outputs predetermined control signals to various kinds of controllers 31 to 34 to control the entire apparatus.

The radiological image storage unit 2b stores two radiological images (referred to as G1 and G2) detected by the radiation detector 15 after radiographing from two different radiographing directions.

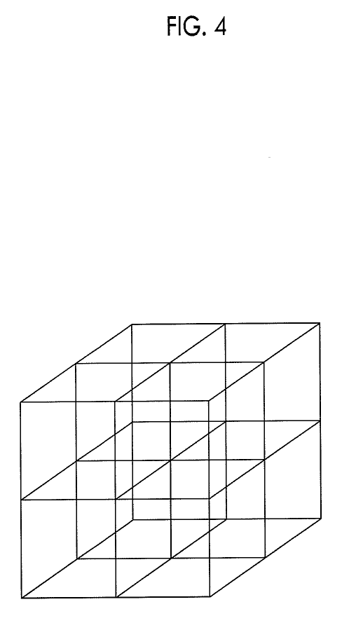

The auxiliary line adding unit 2c adds auxiliary lines H1 and H2 for expressing a sense of depth of a stereoscopic image to two radiological images G1 and G2 so as to be able to be stereoscopically viewed when displaying a stereoscopic image using the two radiological images G1 and G2 on the monitor 3. FIG. 4 is a view showing auxiliary lines. As shown in FIG. 4, auxiliary lines are formed by arraying a plurality of rectangular grids in the depth direction according to the three-dimensional effect of a stereoscopic image. In addition, each grid is divided into a plurality of regions in the shape of a mesh. Moreover, in FIG. 4, the auxiliary line between the grids extending in the depth direction is not an essential element but is provided in order to make the present invention understood more easily. However, since an auxiliary line is easily viewed by providing the auxiliary line in the depth direction, a more effective three-dimensional effect can be achieved.

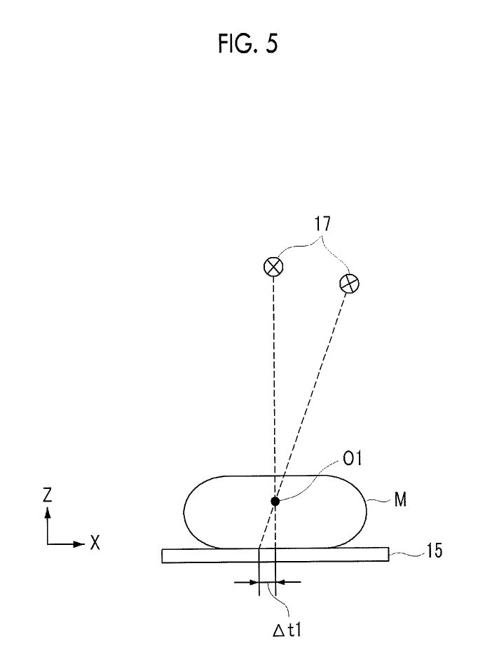

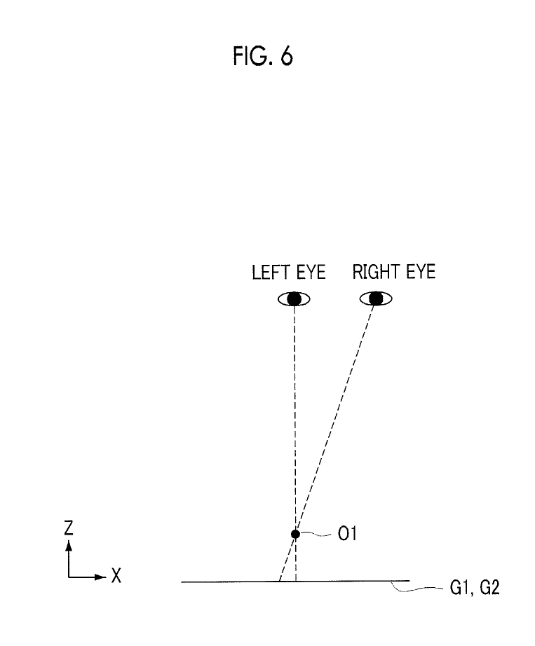

The auxiliary line generating unit 2d generates the auxiliary lines H1 and H2. Hereinafter, the generation of the auxiliary lines H1 and H2 will be described. FIG. 5 is a view showing the positional relationship between a radiation source and a radiation detector at the time of radiographing seen from the right side of FIG. 1, and FIG. 6 is a view showing a state where a stereoscopic image is stereoscopically viewed based on the positional relationship between the radiation source and the radiation detector. As shown in FIG. 5, in the present embodiment, two radiological images G1 and G2 are acquired by radiation emitted from the radiation sources 17 located in two different directions, and parallax Δt1 occurs on the radiological images G1 and G2 due to the positional difference between the radiation sources 17 for a structure (referred to as O1) included in the subject (breast M). In addition, as shown in FIG. 6, when displaying a stereoscopic image using the radiological images G1 and G2, the structure O1 is stereoscopically viewed before the image using parallax when observing the same structure O1 included in the radiological images G1 and G2 with left and right eyes. Moreover, in FIG. 6 and subsequent explanation, the eye located at the left side toward the drawing is assumed to be the left eye.

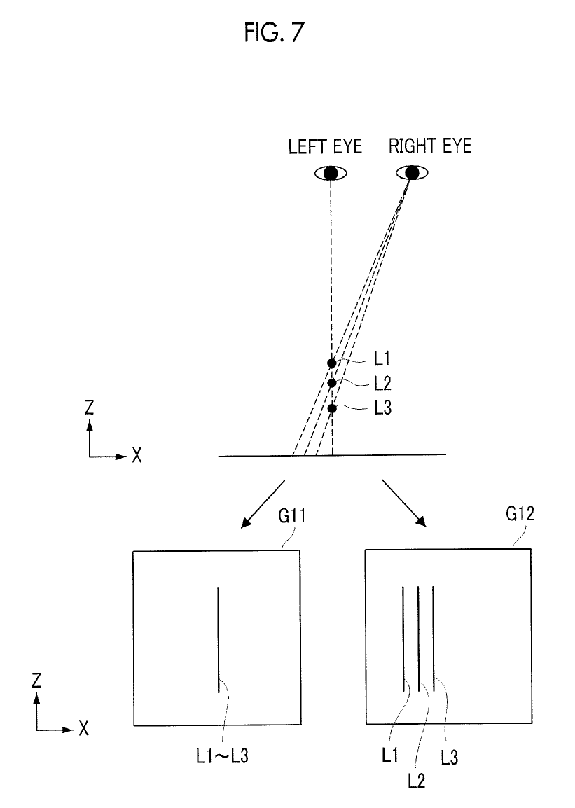

Therefore, for example, if auxiliary lines are generated such that lines L1 to L3 forming three grids exist at the positions immediately below the left eye as shown in FIG. 7 when arraying the three grids in the depth direction according to the three-dimensional effect of a stereoscopic image, it is necessary to generate the auxiliary lines such that the three lines L1 to L3 overlap each other on a radiological image G11 observed by the left eye and the three lines L1 to L3 are disposed at distances therebetween on a radiological image G12 observed by the right eye. In addition, in FIG. 7, the lines L1 to L3 extend in the Y-axis direction.

Stereoscopic viewing is performed using parallax of the corresponding positions when displaying a plurality of images simultaneously. However, if grid lines on the radiological image G11 observed by the left eye overlap each other, it is not clear to which lines on the radiological image G12 observed by the right eye the overlapping lines correspond. For this reason, stereoscopic viewing of auxiliary lines is difficult in a part where grid lines overlap each other. Moreover, even if the arrangement of lines is changed such that grid lines do not overlap each other, it may be difficult to observe a radiological image if a distance between lines which form auxiliary lines is narrow, or the auxiliary lines may flicker and this may lead to the fatigue of eyes.

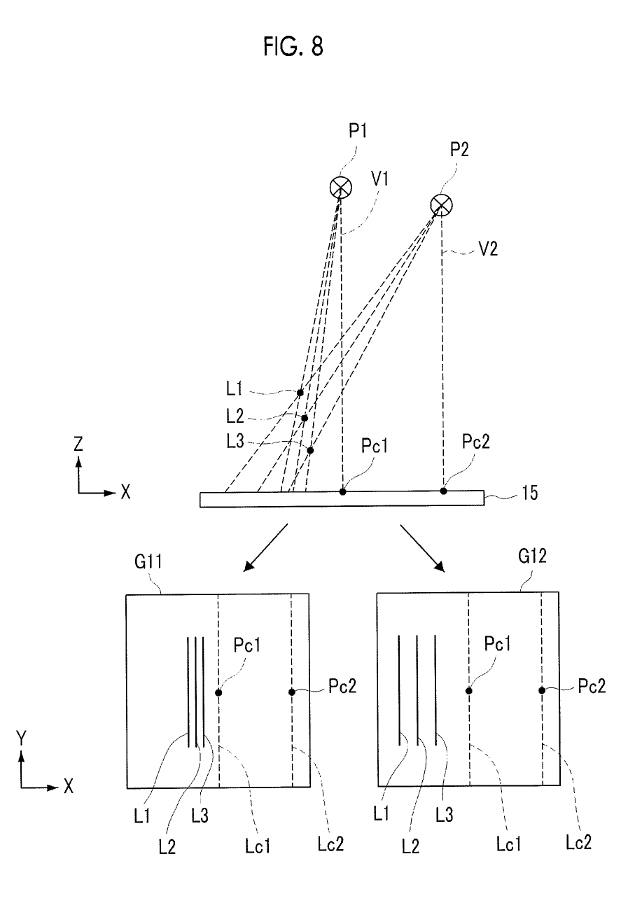

Here, the positions of the left and right eyes when observing a stereoscopic image are equivalent to the positions of the radiation source 17 at the time of radiographing. Accordingly, the auxiliary line generating unit 2d generates the auxiliary lines H1 and H2 such that the lines which form grids are disposed at positions distant from the position vertically facing the radiation source 17, which is a focal point at the time of radiographing on the radiological images G1 and G2, when adding the auxiliary lines H1 and H2 to the radiological images G1 and G2. That is, as shown in FIG. 8, the auxiliary line generating unit 2d generates the auxiliary lines H1 and H2 such that the lines which form grids do not overlap the perpendiculars V1 and V2, which connect two positions P1 and P2 of the radiation source 17 to the radiation detector 15 at the time of radiographing. In addition, in FIG. 8, the lines L1 to L3 extend in the Y-axis direction. Thus, in both the radiological images G1 and G2 acquired when the radiation source 17 is located at each of the positions P1 and P2, the three lines L1 to L3 are disposed at distances therebetween.

Specifically, as shown in FIG. 8, points of intersection Pc1 and Pc2 between the radiation detector 15 and the perpendiculars V1 and V2, which connect the two positions P1 and P2 of the radiation source 17 at the time of radiographing to the radiation detector 15, are calculated. Then, on the radiological images G1 and G2, the auxiliary lines H1 and H2 are generated by disposing a plurality of grids at the positions distant from straight lines Lc1 and Lc2 such that the lines which form grids do not overlap the straight lines Lc1 and Lc2 which pass through the coordinates corresponding to the points of intersection Pc1 and Pc2 and extend in the Y-axis direction. In addition, it is preferable to dispose the lines which form grids so as not to be located in a region equivalent to 30 percent of the distance between the lines, which form one grid, from the straight lines Lc1 and Lc2. In this case, if the distance between the lines which form grids is increased, a distance between regions where the lines which form grids are not disposed is also increased.

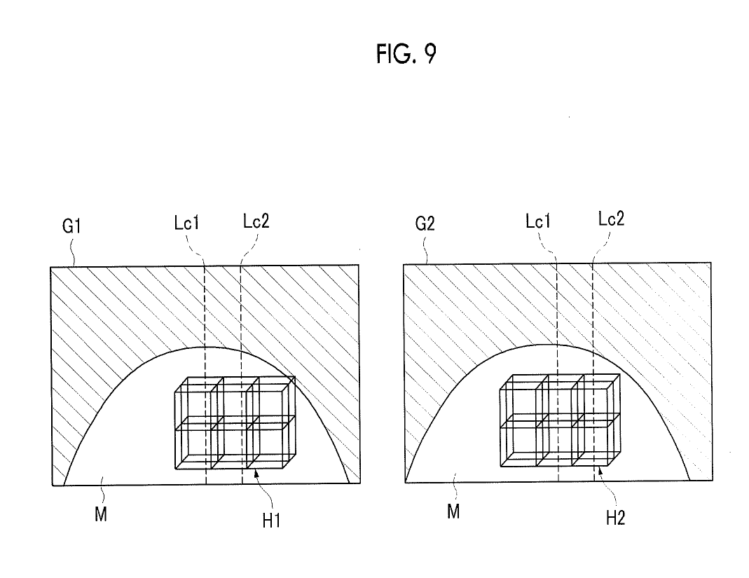

The auxiliary line adding unit 2c adds the auxiliary lines H1 and H2 generated by the auxiliary line generating unit 2d to the radiological images G1 and G2, respectively. FIG. 9 is a view showing two radiological images to which auxiliary lines are added. In addition, in FIG. 9, the positions of the straight lines Lc1 and Lc2 are shown for explanation, and the actual positions are different. As shown in FIG. 9, the auxiliary lines H1 and H2 formed by arraying grids are added to the radiological images G1 and G2 so as to overlap the breast M in the radiological images G1 and G2, respectively. Here, on the radiological images G1 and G2, the lines which form grids do not overlap the straight lines Lc1 and Lc2. In addition, in FIG. 9, each of the auxiliary lines H1 and H2 is formed by three rectangular grids, and each grid is divided into a plurality of regions (here, six regions) in the shape of a mesh. In addition, the positional difference, that is, parallax of each grid on the radiological images G1 and G2 decreases from the front side toward the back side. For this reason, when displaying a stereoscopic image using the radiological images G1 and G2 to which the auxiliary lines H1 and H2 are added, the stereoscopic image is viewed in a state where three grids are arrayed from the front side to the back side.

In addition, the parallax of each grid is preferably determined, for example, so as to divide parallax equally based on the largest parallax and the smallest parallax between the corresponding structures included in the radiological images G1 and G2. In addition, when displaying a stereoscopic image using the radiological images G1 and G2 to which the auxiliary lines H1 and H2 are added, parallax of the auxiliary lines H1 and H2 may be changed by an input from the input unit 4. In this case, the three-dimensional effect of the auxiliary lines can be combined with the three-dimensional effect of the breast M included in the stereoscopic image. In addition, whether to display the auxiliary lines H1 and H2 may be changed by an input from the input unit 4. In addition, since the brightness of a region of the breast M in the radiological images G1 and G2 is relatively high, it is preferable that the brightness of each of the auxiliary lines H1 and H2 be low.

The display control unit 2e performs predetermined processing on the radiological images G1 and G2 to which the auxiliary lines H1 and H2 are added and then displays a stereoscopic image of the breast M on the monitor 3.

The monitor 3 is configured to be able to perform three-dimensional display of a stereoscopic image using the two radiological images G1 and G2 output from the computer 2. As an example of the three-dimensional display method of the monitor 3, a method may be adopted in which two radiological images are displayed using two screens and one of the radiological images is incident on the right eye of an observer and the other radiological image is incident on the left eye of the observer using a half mirror, a polarization glass, and the like to thereby display a stereoscopic image. In addition, a method of displaying a stereoscopic image by superimposing two radiological images and making these radiological images observable with a polarization glass may also be used. In addition, the monitor 3 may be formed by a 3D liquid crystal display, and a method by which stereoscopic viewing of two radiological images is possible, such as a parallax barrier method and a lenticular method, may be used.

The input unit 4 includes a keyboard or a pointing device, such as a mouse, and receives from an operator an input of radiographing conditions, an input of a radiographing start instruction, and the like.

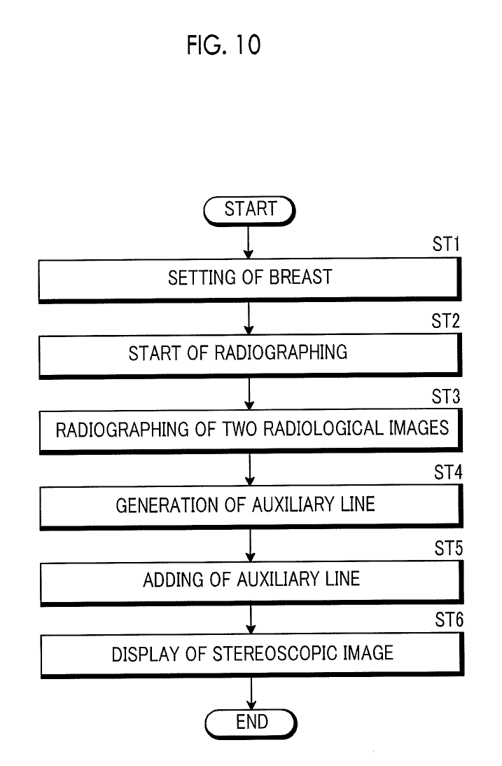

Next, processing performed in the present embodiment will be described. FIG. 10 is a flow chart showing the processing performed in the present embodiment. First, the breast M of a patient is placed on the radiation plane 14 and is compressed with predetermined pressure by the compression plate 18 (step ST1). Then, various radiographing conditions are input through the input unit 4 and then an instruction to start radiographing is input (step ST2).

If there is an instruction to start radiographing through the input unit 4, radiographing of two radiological images for displaying the stereoscopic image of the breast M is performed (step ST3). Specifically, first, the control unit 2a an angle of convergence θ stored and outputs the information regarding the read angle of convergence θ to the arm controller 31. In addition, the arm controller 31 receives the information regarding the angle of convergence θ output from the control unit 2a and outputs a control signal to make the arm unit 13 positioned in a direction perpendicular to the radiation plane 14 (direction of 0°) as shown by the solid line in FIG. 2.

Then, in a state where the arm unit 13 is positioned perpendicular to the radiation plane 14 according to the control signal output from the arm controller 31, the control unit 2a outputs control signals to the radiation source controller 32 and the detector controller 33 in order to perform irradiation and reading of a radiological image signal. In addition, the position of the radiation source 17 in this state becomes a viewpoint as a reference. According to this control signal, radiation is emitted from the radiation source 17, a radiological image obtained by radiographing the breast M from the direction of 0° is detected by the radiation detector 15, a radiological image signal is read from the radiation detector 15 by the detector controller 33, and predetermined signal processing is performed on the radiological image signal. Then, the result is stored as the radiological image G1 as a reference in the radiological image storage unit 2b of the computer 2.

Then, the arm controller 31 outputs a control signal to make the arm unit 13 rotate by +θ° in a direction perpendicular to the radiation plane 14 as shown by the virtual line in FIG. 2. Then, in a state where the arm unit 13 has rotated by +θ° according to the control signal output from the arm controller 31, the control unit 2a outputs control signals to the radiation source controller 32 and the detector controller 33 in order to perform irradiation and reading of a radiological image signal. According to this control signal, radiation is emitted from the radiation source 17, a radiological image obtained by radiographing the breast M from the direction of +θ° is detected by the radiation detector 15, a radiological image signal is read by the detector controller 33, and predetermined signal processing is performed. Then, the result is stored as the radiological image G2 in the radiological image storage unit 2b of the computer 2.

Then, the two radiological images G1 and G2 stored in the radiological image storage unit 2b are read, and the auxiliary lines H1 and H2 added to the radiological images G1 and G2 are generated by the auxiliary line generating unit 2d (step ST4). Then, the auxiliary line adding unit 2c adds the auxiliary lines H1 and H2 to the radiological images G1 and G2, respectively (step ST5). Then, predetermined processing is performed on radiological images GS1 and GS2, to which the auxiliary lines H1 and H2 are added, by the display control unit 2e. Then, the result is output to the monitor 3, and a stereoscopic image of the breast M is displayed on the monitor 3 (step ST6).

Thus, in the present embodiment, when adding the auxiliary lines H1 and H2 to the radiological images G1 and G2, the auxiliary lines H1 and H2 are generated such that the lines which form grids are disposed at positions distant from the position vertically facing the radiation source 17 at the time of radiographing on the radiological images G1 and G2. For this reason, the auxiliary lines H1 and H2 can be generated such that the lines which form all grids are located far from the position vertically facing the radiation source 17. As a result, it is possible to prevent stereoscopic viewing of the auxiliary lines H1 and H2 from becoming difficult when displaying a stereoscopic image using the radiological images G1 and G2 to which the auxiliary lines H1 and H2 are added. In addition, since the distance between lines which form the auxiliary lines H1 and H2 is increased, it becomes easy to observe a stereoscopic image. In addition, since flickering of the auxiliary lines H1 and H2 can be suppressed, the fatigue of eyes can also be prevented.

Next, a second embodiment of the present invention will be described. In addition, the configuration of a radiological image radiographing apparatus to which a radiological image display device according to the second embodiment is added is the same as the configuration of the radiological image radiographing apparatus according to the first embodiment of the present invention, and only processing performed is different. Accordingly, detailed explanation on the configuration will be omitted herein. The second embodiment of the present invention is different from the first embodiment in that the auxiliary lines H1 and H2 are generated such that the lines which form the auxiliary lines H1 and H2 are disposed at positions distant from the position, which bisects the positions vertically facing a plurality of focal points at the time of radiographing when acquiring the radiological images G1 and G2, on the radiological images G1 and G2.

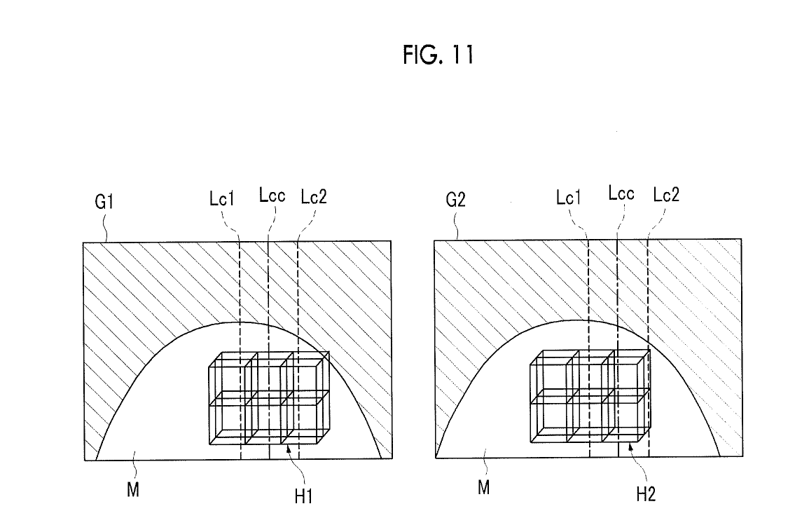

FIG. 11 is a view showing a state where the auxiliary lines generated in the second embodiment are added to a radiological image. In FIG. 11, straight lines Lc1 and Lc2 are straight lines that pass through the coordinates corresponding to the points of intersection Pc1 and Pc2 between the radiation detector 15 and the perpendiculars V1 and V2, which connect the two positions P1 and P2 of the radiation source 17 at the time of radiographing to the radiation detector 15, and that extend in the Y-axis direction, similar to the straight lines Lc1 and Lc2 shown in FIG. 8. In addition, the straight line Lcc is a line which bisects a distance between the straight lines Lc1 and Lc2. Hereinafter, the straight line Lcc is called a bisector Lcc. In addition, in FIG. 11, the positions of the straight lines Lc1 and Lc2 and the bisector Lcc are shown for explanation, and the actual positions are different. As shown in FIG. 11, lines which form the auxiliary lines H1 and H2 are disposed at the positions distant from the bisector Lcc in each of the radiological images G1 and G2. In addition, it is preferable to dispose the lines which form grids so as not to be located in a region equivalent to 30 percent of the distance between the lines, which form one grid, from the bisector Lcc. In addition, it is preferable that distances of lines, which form corresponding grids, from the bisector Lee in the radiological images G1 and G2 be set differently.

If the lines which form the auxiliary lines H1 and H2 are located at the bisector Lcc, lines which form the grids are located on the position which bisects focal points (that is, eyes of the observer) at the time of stereoscopic viewing of the radiological images G1 and G2. Therefore, from the characteristics of human vision, it is clear from the experiments of this applicant that the lines which form grids cannot be stereoscopically viewed well.

According to the second embodiment of the present invention, when adding the auxiliary lines H1 and H2 to radiological images, the auxiliary lines H1 and H2 are generated such that the lines which form grids are disposed at positions distant from the bisector Lcc. Accordingly, when performing stereoscopic viewing, the lines which form grids are not located at the position which bisects the eyes of the observer. As a result, it is possible to prevent stereoscopic viewing of the auxiliary lines from becoming difficult.

In addition, in the first embodiment described above, the lines which form grids of the auxiliary lines H1 and H2 shown in FIG. 9 may be disposed at the positions distant from the bisector Lcc of the straight lines Lc1 and Lc2. In this case, when performing stereoscopic viewing, the lines which form grids are not located at the position which bisects the eyes of the observer. As a result, it is possible to prevent stereoscopic viewing of the auxiliary lines H1 and H2 from becoming difficult.

However, when disposing the lines which form grids at the positions distant from the position vertically facing the radiation source 17 at the time of radiographing on the radiological images G1 and G2, the lines which form grids may not be disposed at the positions distant from the bisector Lcc of the straight lines Lc1 and Lc2. In such a case, it is preferable to generate the auxiliary lines H1 and H2 in a state where priority is given to disposing the lines which form grids at the positions distant from the bisector Lcc of the straight lines Lc1 and Lc2.

Moreover, in the embodiment described above, auxiliary lines formed by arraying three grids in the depth direction are generated. However, it is also possible to use an arbitrary number according to the three-dimensional effect of a stereoscopic image as long as the number of grids is 2 or more. In addition, the arbitrary number of divisions may also be used as the number of divisions of mesh-like regions in a grid.

In addition, although the rectangular grid is used in the embodiment described above, it is also possible to use a grid with any kind of shape, such as a circle or a triangle.

In addition, although a radiological image acquired by radiographing the breast M from the direction of 0° is used as the radiological image G1 as a reference in the embodiment described above, an image acquired by radiographing the breast M from a different direction from 0° may be used as a reference of two radiological images for displaying a stereoscopic image. In this case, a stereoscopic image is preferably displayed using a radiological image radiographed from the different direction from 0° as the radiological image G1 as a reference.

In addition, although the radiological image radiographing apparatus to which the radiological image display device according to the above-described embodiment of the present invention is added is used as an apparatus which radiographs a radiological image of a breast, the subject is not limited to a breast. For example, a radiological image radiographing apparatus which radiographs a chest, a head, and the like may also be used.

What is claimed is:

1. A radiological image display device comprising:
an image acquisition unit that acquires a plurality of radiological images for displaying a stereoscopic image of a subject;
a display control unit that displays the stereoscopic image on a display unit using the plurality of radiological images;
an auxiliary line adding unit that adds auxiliary lines, which are formed by arraying a plurality of grids each of which is divided into a plurality of regions in the shape of a mesh so as to be viewed in a depth direction, to the plurality of radiological images so as to be able to be stereoscopically viewed; and
an auxiliary line generating unit that generates the auxiliary lines forming the grids are disposed at positions, which are distant from a position vertically facing a focal point at the time of radiographing, on the radiological images when adding the auxiliary lines to the radiological images.

2. The radiological image display device according to claim 1,
wherein the auxiliary line generating unit is a unit that generates the auxiliary lines forming the grids are disposed at positions distant from a position, which bisects positions vertically facing a plurality of focal points at the time of radiographing when acquiring the plurality of radiological images, on each of the radiological images when adding the auxiliary lines to the radiological images.

3. A radiological image display device comprising:
an image acquisition unit that acquires a plurality of radiological images for displaying a stereoscopic image of a subject;
a display control unit that displays the stereoscopic image on a display unit using the plurality of radiological images;
an auxiliary line adding unit that adds auxiliary lines, which are formed by arraying a plurality of grids each of which is divided into a plurality of regions in the shape of a mesh so as to be viewed in a depth direction, to the plurality of radiological images so as to be able to be stereoscopically viewed; and
an auxiliary line generating unit that generates the auxiliary lines forming the grids are disposed at positions distant from a position, which bisects positions vertically facing a plurality of focal points at the time of radiographing when acquiring the plurality of radiological images, on each of the radiological images when adding the auxiliary lines to the radiological images.

4. A radiological image display method in a radiological image display device including an image acquisition unit that acquires a plurality of radiological images for displaying a stereoscopic image of a subject and a display control unit that displays the stereoscopic image on a display unit using the plurality of radiological images, the method comprising:
when adding auxiliary lines, which are formed by arraying a plurality of grids each of which is divided into a plurality of regions in the shape of a mesh so as to be viewed in a depth direction, to the plurality of radiological images so as to be able to be stereoscopically viewed, generating the auxiliary lines such that lines which form the grids are disposed at positions, which are distant from a position vertically facing a focal point at the time of radiographing, on the radiological images.

5. A radiological image display method in a radiological image display device including an image acquisition unit that acquires a plurality of radiological images for displaying a stereoscopic image of a subject and a display control unit that displays the stereoscopic image on a display unit using the plurality of radiological images, the method comprising:
when adding auxiliary lines, which are formed by arraying a plurality of grids each of which is divided into a plurality of regions in the shape of a mesh so as to be viewed in a depth direction, to the plurality of radiological images so as to be able to be stereoscopically viewed, generating the auxiliary lines such that lines which form the grids are disposed at positions distant from a position, which bisects positions vertically facing a plurality of focal points at the time of radiographing when acquiring the plurality of radiological images, on each of the radiological images.
